(19) United States
(12) Patent Application Publication
(10) Pub. No.: US 2008/0162687 A1
(43) Pub. Date: Jul. 3, 2008

(54) DATA ACQUISITION SYSTEM AND METHOD

(76) Inventor: David Alan Scott, Kamuela, HI (US)

Correspondence Address: HOLLAND & KNIGHT, 10 ST. JAMES AVENUE, BOSTON, MA, 02116-3889, US

(21) Appl. No.: 11/617,636

(22) Filed: Dec. 28, 2006

(51) Int. Cl. G06F 15/173

(52) U.S. Cl. 709/224

(57) ABSTRACT

A method and computer program product for capturing data includes monitoring a plurality of inbound data elements that are received by a webserver that serves a website. At least a portion of the plurality of inbound data elements are written to a log file for the website. A plurality of outbound data elements that are to be transmitted by the webserver in response, at least in part, to the inbound data elements are monitored. At least a portion of the outbound data elements are written to the log file for the website.

### TECHNICAL FIELD

This disclosure relates to capturing data and, more particularly, to capturing data received by and transmitted from a web-server.

### BACKGROUND

Web applications may be tested for security issues through various technologies that determine the vulnerability of the web application under test. For example, current technologies may use e.g., a “spider” or a “proxy server” to record the various paths through a web application and may analyze and generate scripts for testing the website.

While these approaches may produce effective scripts for testing various security “holes”, there are shortcomings. For example, using “spiders” to evaluate web applications may produce data that includes many combinations of possible interactions with the web application. Unfortunately, this may result in many application flows that are not typical of real usage. Further, they may miss critical flows through an application because the input data fed to the spider is not complete enough to drive the complete application.

Further, while using a “proxy server” to record a real “human” user (performing real activities) may generate an interactive flow that mimics real life, the tester performing the test may not adequately record all appropriate flows. Unfortunately, this may produce a false sense of security concerning the quality of the website.

### SUMMARY OF DISCLOSURE

In a first implementation of this disclosure, a method of capturing data includes monitoring a plurality of inbound data elements that are received by a webserver that serves a website. At least a portion of the plurality of inbound data elements are written to a log file for the website. A plurality of outbound data elements that are to be transmitted by the webserver in response, at least in part, to the inbound data elements are monitored. At least a portion of the outbound data elements are written to the log file for the website.

One or more of the following features may also be included. A session identifier may be assigned to one or more of the inbound and outbound data elements. The session identifier may be written to the log file for the website. A timestamp may be assigned to one or more of the inbound and outbound data elements. The timestamp may be written to the log file for the website. The outbound data elements may include one or more of: JavaScript; cookies; POST data; HTML code; ASCII text; graphical elements; binary data, executable data, XML-formatted data, and formatted SOAP requests/responses. The outbound data elements may define at least a portion of a webpage served by the webserver and included within the website.

In another implementation of this disclosure, a computer program product includes a computer useable medium having a computer readable program. The computer readable program, when executed on a computer, causes the computer to monitor a plurality of inbound data elements that are received by a webserver that serves a website. At least a portion of the plurality of inbound data elements are written to a log file for the website. A plurality of outbound data elements that are to be transmitted by the webserver in response, at least in part, to the inbound data elements are monitored. At least a portion of the outbound data elements are written to the log file for the website.

One or more of the following features may also be included. A session identifier may be assigned to one or more of the inbound and outbound data elements. The session identifier may be written to the log file for the website. A timestamp may be assigned to one or more of the inbound and outbound data elements. The timestamp may be written to the log file for the website. The outbound data elements may include one or more of: JavaScript; cookies; POST data; HTML code; ASCII text; graphical elements; binary data, executable data, XML-formatted data, and formatted SOAP requests/responses. The outbound data elements may define at least a portion of a webpage served by the webserver and included within the website.

In another implementation of this disclosure, a method of analyzing data includes defining a log file that includes a plurality of inbound data elements that are received by a webserver, and a plurality of outbound data elements that are to be transmitted by the webserver in response, at least in part, to the inbound data elements. The log file is parsed into individual sessions.

One or more of the following features may also be included. The outbound data elements may include one or more of: JavaScript; cookies; POST data; HTML code; ASCII text; graphical elements; binary data, executable data, XML-formatted data, and formatted SOAP requests/responses. The outbound data elements may define at least a portion of a webpage served by the webserver. The log file may include one or more session identifiers and one or more timestamps. One or more usage parameters may be determined for one or more portions of the website. One or more vulnerabilities may be determined for one or more portions of the website.

In another implementation of this disclosure, a computer program product includes a computer useable medium having a computer readable program. The computer readable program, when executed on a computer, causes the computer to define a log file that includes a plurality of inbound data elements that are received by a webserver, and a plurality of outbound data elements that are to be transmitted by the webserver in response, at least in part, to the inbound data elements. The log file is parsed into individual sessions.

One or more of the following features may also be included. The outbound data elements may include one or more of: JavaScript; cookies; POST data; HTML code; ASCII text; graphical elements; binary data, executable data, XML-formatted data, and formatted SOAP requests/responses. The outbound data elements may define at least a portion of a webpage served by the webserver. The log file may include one or more session identifiers and one or more timestamps. One or more usage parameters may be determined for one or more portions of the website. One or more vulnerabilities may be determined for one or more portions of the website.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a data acquisition process executed in whole or in part by a computer coupled to a distributed computing network;

FIG. 2 is a diagrammatic view of a website hosted by a computer of FIG. 1;

FIG. 3 is a flowchart of the data acquisition process of FIG. 1;

FIG. 4 is a diagrammatic view of a log file generated by the data acquisition process of FIG. 1;

FIG. 5 is a diagrammatic view of a modified log file generated by the data acquisition process of FIG. 1;

FIG. 6 is a session flow graph;

FIG. 7 is a session flow graph;

FIG. 8 is a session flow graph;

FIG. 9 is a session flow graph; and

FIG. 10 is a session flow graph.

### DETAILED DESCRIPTION OF THE PREFERRED EMBODIMENTS

### Overview:

As will be discussed below in greater detail, this disclosure may take the form of an entirely hardware embodiment, an entirely software embodiment or an embodiment containing both hardware and software elements. In a preferred embodiment, this disclosure may be implemented in software, which may include but is not limited to firmware, resident software, microcode, etc.

Furthermore, this disclosure may take the form of a computer program product accessible from a computer-usable or computer-readable medium providing program code for use by or in connection with a computer or any instruction execution system. For the purposes of this description, a computer-usable or computer readable medium may be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks may include, but are not limited to, compact disc—read only memory (CD-ROM), compact disc—read/write (CD-R/W) and DVD.

A data processing system suitable for storing and/or executing program code may include at least one processor coupled directly or indirectly to memory elements through a system bus. The memory elements may include local memory employed during actual execution of the program code, bulk storage, and cache memories which may provide temporary storage of at least some program code in order to reduce the number of times code must be retrieved from bulk storage during execution.

Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

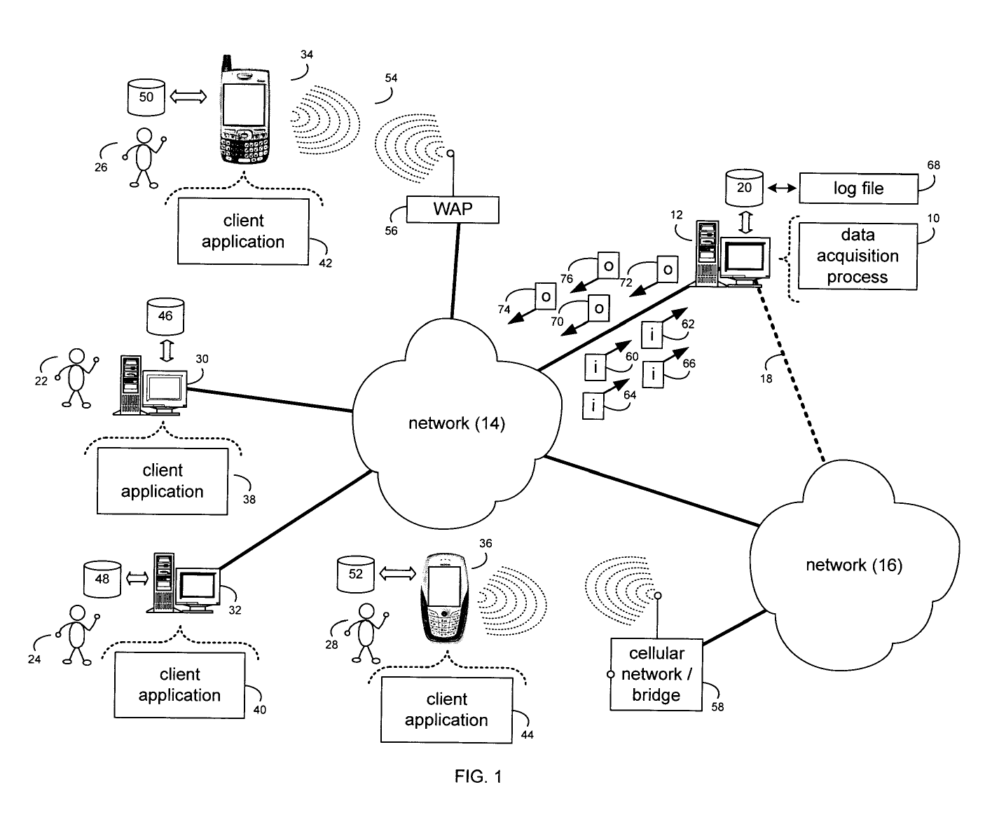

Referring to FIG. 1, there is shown a data acquisition process 10 resident on (in whole or in part) and executed by (in whole or in part) server computer 12 (e.g., a single server computer, a plurality of server computers, or a general purpose computer, for example). As will be discussed below in greater detail, data acquisition process 10 may monitor and log all data elements received by and transmitted from server computer 12.

Server computer 12 may be coupled to distributed computing network 14 (e.g., the Internet). Server computer 12 may be, for example, a web server running a network operating system, examples of which may include but are not limited to Microsoft Windows XP Server™, or Redhat Linux™.

Server computer 12 may also execute a web server application, examples of which may include but are not limited to Microsoft IIS™, or Apache Webserver™, that allows for HTTP (i.e., HyperText Transfer Protocol) access to server computer 12 via network 14. Network 14 may be coupled to one or more secondary networks (e.g., network 16), such as: a local area network; a wide area network; or an intranet, for example. Additionally/alternatively, server computer 12 may be coupled to network 14 through secondary network 16, as illustrated with phantom link line 18.

The instruction sets and subroutines of data acquisition process 10, which may be stored on a storage device 20 coupled to server computer 12, may be executed by one or more processors (not shown) and one or more memory architectures (not shown) incorporated into server computer 12. Storage device 20 may include, but is not limited to, a hard disk drive, a tape drive, an optical drive, a RAID array, a random access memory (RAM), or a read-only memory (ROM). Data acquisition process 10 may be incorporated into or an applet of the above-described web server application.

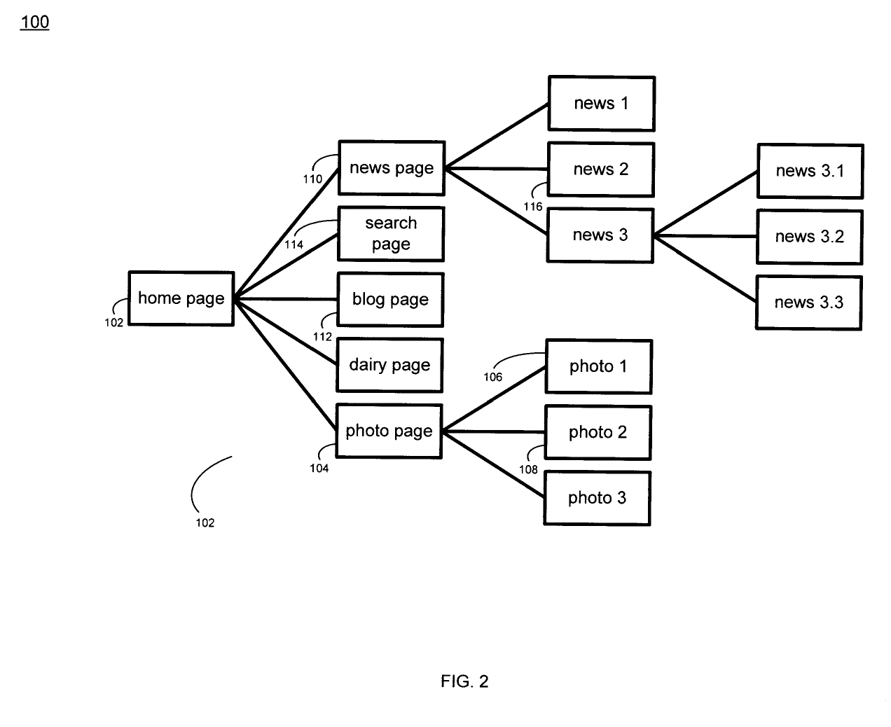

Referring also to FIG. 2, server computer 12 may host one or more websites (e.g., website 100), which may include one or more webpages that may be arranged in a hierarchical fashion. Users 22, 24, 26, 28 may access the one or more websites (e.g., website 100) using one or more user computing devices, examples of which may include but are not limited to: user computer 30, user computer 32, personal digital assistant 34, data-enabled cellular telephone 36, laptop computers (not shown), notebook computers (not shown), cable boxes (not shown), televisions (not shown), gaming consoles (not shown), and dedicated network appliances (not shown), for example.

User computer 30, user computer 32, personal digital assistant 34, and data-enabled cellular telephone 36 may each execute a client application 38, 40, 42, 44, (respectively) that allows e.g., users 22, 24, 26, 28 to access server computer 12 and the one or more websites (e.g., website 100) hosted by server computer 12. Examples of client application 38, 40, 42, 44 may include, but are not limited to, web browser applications such as Microsoft Internet Explorer™, Mozilla Firefox™, and Netscape Navigator™)

The instruction sets and subroutines of client application 38, 40, 42, 44, which may be stored on a storage devices 46, 48, 50, 52 (respectively) coupled to user computers 30, 32, personal digital assistant 34, and data-enabled cellular telephone 36 (respectively), may be executed by one or more processors (not shown) and one or more memory architectures (not shown) incorporated into user computers 30, 32, personal digital assistant 34, and data-enabled cellular telephone 36. Storage devices 46, 48, 50, 52 may include, but are not limited to, a hard disk drive, a tape drive, an optical drive, a RAID array, a random access memory (RAM), a read-only memory (ROM), a compact flash (CF) storage device, a secure digital (SD) storage device, and a memory stick storage device.

User computers 30, 32, personal digital assistant 34, and data-enabled cellular telephone 36 may execute an operating system, examples of which may include, but are not limited to, Microsoft Windows XP™, Microsoft Windows Mobile™, and Redhat Linux™.

The various computing devices (e.g., user computer 30, user computer 32, personal digital assistant 34, data-enabled cellular telephone 36) may be directly or indirectly coupled to network 14 (or network 16). For example, user computers 32, 34 are shown directly coupled to network 14 via hardwired network connections. Further, personal digital assistant 34 is shown wirelessly coupled to network 14 via a wireless communication channel 54 established between personal digital assistant 34 and wireless access point (i.e., WAP) 56, which is shown directly coupled to network 14. Additionally, cellular telephone 36 is shown wirelessly coupled to cellular network/bridge 58, which is shown directly coupled to network 14.

WAP 56 may be, for example, an IEEE 802.11a, 802.11b, 802.11g, Wi-Fi, and/or Bluetooth device that is capable of establishing secure communication channel 54 between personal digital assistant 34 and WAP 56.

As is known in the art, all of the IEEE 802.11x specifications use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Data Acquisition Process Operation:

As discussed above, data acquisition process 10 may monitor and log all data elements received by and transmitted from server computer 12. As users 22, 24, 26, 28 access the various portions of e.g., website 100 (via e.g., client applications 38, 40, 42, 44 respectively), user computers 30, 32, personal digital assistant 34, and data-enabled cellular telephone 36 (respectively) may provide inbound data elements (e.g., elements 60, 62, 64, 66) to server computer 12. Examples of these inbound data elements may include, but are not limited to, webpage requests, form data that was entered into forms included within the webpages of e.g., website 100; JavaScript; cookies; POST data; HTML code; ASCII text; graphical elements; binary data, executable data, XML-formatted data, and formatted SOAP requests/responses.

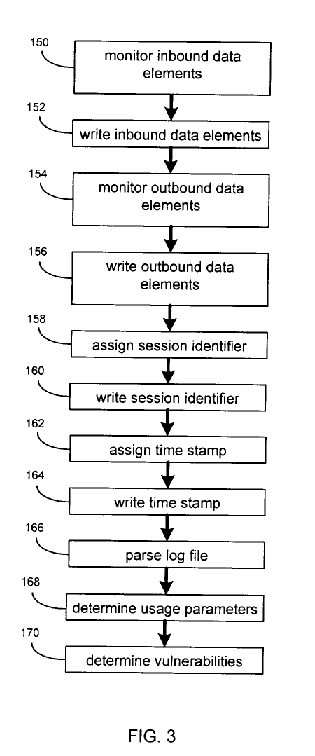

Referring also to FIG. 3, data acquisition process 10 may monitor 150 these inbound data elements (e.g., elements 60, 62, 64, 66) received by server computer 12, which may serves website 100. At least a portion of the plurality of inbound data elements (e.g., elements 60, 62, 64, 66) may be written to log file 68, which may be associated with the website for which data is being acquired (e.g., website 100).

Log file 68 may be structured in various ways, all of which are considered to be within the scope of this disclosure. For example, log file 68 may be a tabular ASCII file that defines the various data elements being monitored 150, 154 by data acquisition process 10. Alternatively, log file 68 may be a database in which e.g., a record is established for each unique session (to be discussed below in greater detail). Log file 68 may be stored on storage device 20 coupled to server computer 12.

In response to the data elements (e.g., elements 60, 62, 64, 66) received by server computer 12, server computer 12 generally (and the above-described web server application specifically) may transmit a plurality of outbound data elements (e.g., elements 70, 72, 74, 76) to the appropriate recipient (e.g., user computer 30, user computer 32, personal digital assistant 34, data-enabled cellular telephone 36).

Data acquisition process 10 may monitor 154 the transmitted data elements (e.g., elements 70, 72, 74, 76). At least a portion of the plurality of outbound data elements (e.g., elements 70, 72, 74, 76) may be written 156 to log file 68, which may be associated with the website for which data is being acquired (e.g., website 100). Examples of these outbound data elements may include, but are not limited to, JavaScript; cookies; POST data; HTML code; ASCII text; graphical elements; binary data, executable data, XML-formatted data, and formatted SOAP requests/responses.

For example, assume that user 22 (via computer 30) would like to visit the homepage 102 of website 100. User 22 may type e.g., “www.homepage.com” into client application 38 (which is executed by user computer 30). Through the use of various network devices (e.g., DNS servers and intermediate networks devices), the appropriate inbound data elements (e.g., data elements 60) may be received by e.g. server computer 12. As data acquisition process 10 is monitoring 150 the inbound data elements received by server computer 12, data acquisition process 10 may write 152 the received inbound data elements to log file 68. Log file 68 may contain e.g., the actual data elements received (e.g., request for homepage 200, form data that was entered into forms included within the webpages of e.g., website 100; JavaScript; cookies; POST data; HTML code; ASCII text; graphical elements; binary data, executable data, XML-formatted data, and formatted SOAP requests/responses) or pointers that locate the data elements received (which may be stored on e.g., storage device 20 coupled to server computer 12).

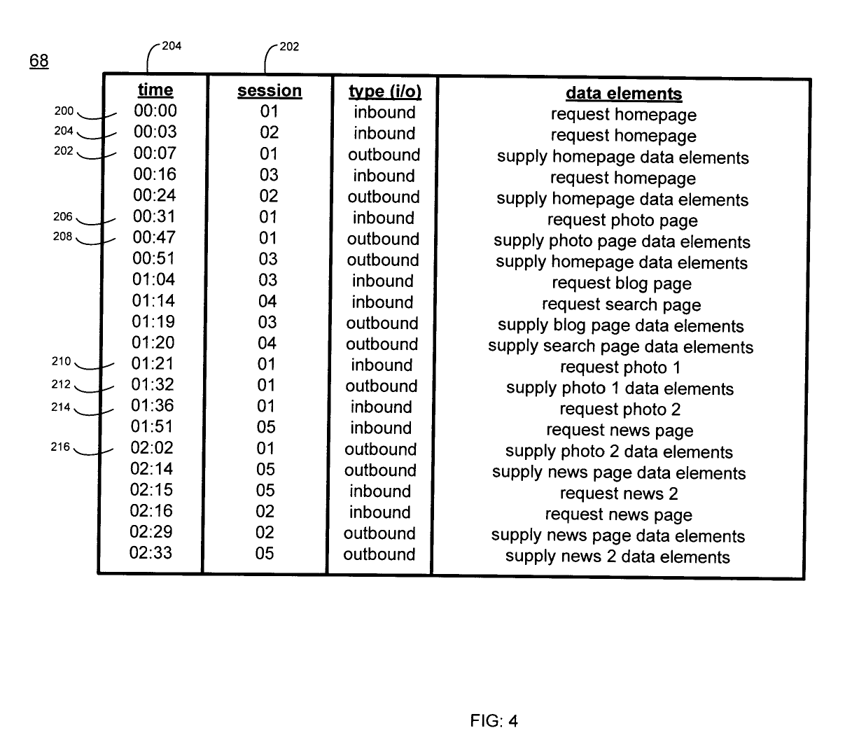

Referring also to FIG. 4, when writing 152, 156 to log file 68, log file 68 may be populated with entries itemizing the data elements received by server computer 12. For example, line item 200 is illustrative of the request received (e.g., inbound data elements 60) by server computer 12 from user computer 30, which requested homepage 102 of website 100.

Data acquisition process 10 may assign 158 a session identifier 202 to the communication session established between user computer 30 and server computer 12. For example, assume that the above-described communication session is assigned 158 session identifier “01”. Data acquisition process 10 may write 160 session identifier 202 to log file 68 (within line item 200).

Data acquisition process 10 may also assign 162 timestamp 204 to one or more of the inbound data elements (e.g., data elements 60) received by e.g., server computer 12. Timestamp 204 may be e.g., the actual time of day or a sequential numbering system that allows for the generation of a temporal record of the data elements received by and transmitted from server computer 12. Data acquisition process 10 may write 164 timestamp 204 (e.g., time 00:00) to log file 68 (within line item 200).

As discussed above, in response to the inbound data elements (e.g., elements 60, 62, 64, 66) being received by server computer 12, server computer 12 may transmit a plurality of outbound data elements (e.g., elements 70, 72, 74, 76) to the appropriate recipients. Continuing with the above-stated example, as (in line item 200) user computer 30 requested homepage 102 of website 100, the web server application may fulfill that request by providing outbound data elements 70 (e.g., the JavaScript; cookies; POST data; HTML code; ASCII text; graphical elements; binary data, executable data, XML-formatted data, and formatted SOAP requests/responses of homepage 102) to user computer 30. As data acquisition process 10 is monitoring 154 the outbound data elements transmitted by server computer 12, data acquisition process 10 may write 156 the outbound data elements transmitted to log file 68. As with the received data elements discussed above, log file 68 may contain e.g., the actual data elements transmitted (e.g., the JavaScript; cookies; POST data; HTML code; ASCII text; graphical elements; binary data, executable data, XML-formatted data, and formatted SOAP requests/responses of homepage 102) or pointers that locate the data elements transmitted (which may be stored on e.g., storage device 20 coupled to server computer 12).

Log file 68 may be populated with an entry that itemizes the data elements transmitted by server computer 12. For example, line item 202 is illustrative of the data elements (e.g., outbound data elements 70) transmitted by server computer 12 (to user computer 30) in response to the previously-received request for homepage 102 (as defined in line item 200).

Continuing with the above-stated example, assume that prior to server computer 12 transmitting data element 70 (as defined in line item 202) to user computer 30, a request is received from user computer 32, which also requests “homepage” 102 of website 100. Data acquisition process 10 may assign 158 a session identifier 202, which may be written 160 to log file 68 (within line item 204). As this is a new communication session (i.e., between server computer 12 and user computer 32), a new session identifier may be assigned 158 (namely “02”). Data acquisition process 10 may further assign 162 a timestamp 204 (namely 00:03), which is written 164 to log file 68 (within line item 204).

This process of monitoring 150 inbound data elements received, assigning 158, 162 session identifiers and timestamps to the inbound data elements, and writing 152 the inbound data elements (as illustrated by e.g., line items 200, 204) to log file 68 may be repeated for all inbound data elements received by server computer 12. Further, the process of monitoring 154 outbound data elements transmitted, assigning 158, 162 session identifiers and timestamps to the outbound data elements, and writing 156 the outbound data elements (as illustrated by e.g., line item 202) may be repeated for all data elements transmitted by server computer 12.

As each “inbound” line item (e.g., line item 200) included within log file 68 defines the inbound data elements received (e.g., inbound data element 60), the time it was received (via timestamp 204) and the session identifier 202 for that particular communication session, the sum of the “inbound” line items included within log file 68 forms a chronology of all inbound data elements received by server computer 12.

Further, as each “outbound” line item (e.g., line item 202) included within log file 68 defines the outbound data elements transmitted (e.g., outbound data element 70), the time it was received (via timestamp 204) and the session identifier 202 for that particular communication session, the sum of the “outbound” line items included within log file 68 forms a chronology of all outbound data elements transmitted by server computer 12.

Accordingly, the combination of all “inbound” and “outbound” line items within log file 68 forms a chronology of all data elements received by or transmitted from server computer 12.

For example, for session “01” (i.e., the session between user computer 30 and server computer 12, user 22 first requested “homepage” 102 (see line item 200); server computer 12 then provided “homepage” 102 (see line item 202); user 22 then requested “photo page” 104 (see line item 206); server computer 12 then provided “photo page” 104 (see line item 208); user 22 then requested “photo 1” 106 (see line item 210); server computer 12 then provided “photo 1” 106 (see line item 212); user 22 then requested “photo 2” 108 (see line item 214); and server computer 12 then provided “photo 2” 108 (see line item 216).

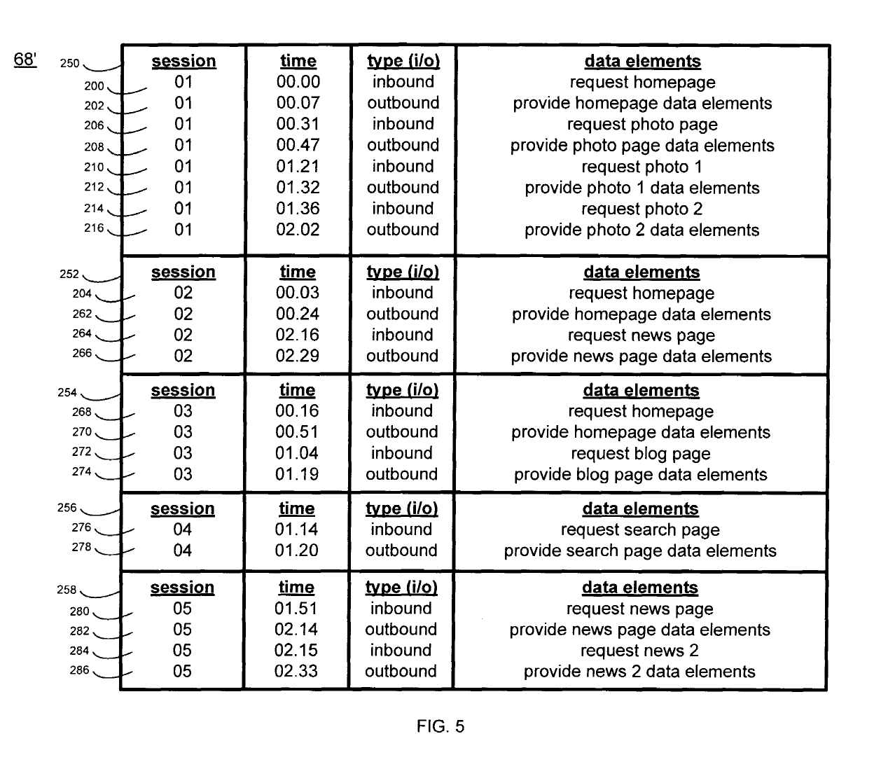

Data acquisition process 10 may parse 166 log file 68 to aid in the processing of log file 68. For example and referring also to FIG. 5, log file 68 may be parsed 166 to sort log file 68 according to sessions identifiers, thus generating modified log file 68′.

Referring also to FIG. 5, modified log file 68′ may allow the reviewer of the log file to quickly determine what data elements were received and transmitted by server computer 12 during each communication session. For example, modified log file 68′ is shown to include five separate session sections 250, 252, 254, 256, 258, one for each of communication sessions “01”, “02” “03”, “04” & “05” respectively.

By reviewing a particular session section (e.g., session sections 250, 252, 254, 256, 258) of modified log file 68′, the reviewer may easily determine what was transmitted from and received by server computer 12 during that particular communication session.

For example and as shown in session section 252, during communication session “02” (i.e., the session between user computer 32 and server computer 12): user computer 32 requested “homepage” 102 (see line item 204); server computer 12 then provided “homepage” 102 (see item 262); user computer 32 then requested “news page” 110 (see line item 264); and server computer 12 then provided “news page” 110 (see line item 266).

As shown in session section 254, during communication session “03” (i.e., the session between personal digital assistant 34 and server computer 12): personal digital assistant 34 requested “homepage” 102 (see line item 268); server computer 12 then provided “homepage” 102 (see item 270); personal digital assistant 34 then requested “blog page” 112 (see line item 272); and server computer 12 then provided “blog page” 112 (see line item 274).

As shown in session section 256, during communication session “04” (i.e., the session between data-enabled cellular telephone 36 and server computer 12): data-enabled cellular telephone 36 requested “search page” 114 (see line item 276); and server computer 12 then provided “search page” 114 (see item 278).

Session section 258 may represent a communication session established between server computer 12 and a fifth user computing devices (not shown). Alternatively, session section 258 may represent a subsequent communication session established between server computer 12 and e.g., personal digital assistant 34. For example, assume that after line item 274 (i.e., server computer 12 providing “blog page” 108 to personal digital assistant 34, personal digital assistant 34 terminated session “03”. Further assume that at time 01:51 (approximately thirty-two minutes later), personal digital assistant 34 contacted server computer 12 for additional data. Accordingly and as shown in session section 258, during communication session “05” (i.e., the second communication session between personal digital assistant 34 and server computer 12): personal digital assistant 34 requested “news page” 110 (see line item 280); server computer 12 then provided “news page” 110 (see item 282); personal digital assistant 34 then requested “news 2” 116 (see line item 284); and server computer 12 then provided “news 2” 116 (see line item 286).

By processing the data included within log file 68 or modified log file 68′, data acquisition process 10 may determine 168 usage parameters for e.g., website 100. For example, of the eleven times that server computer 12 provide e.g., webpages, photos, and new articles (via e.g., outbound data elements 70, 72, 74, 76): “homepage” 102 was provided three times (i.e., 27.27%); “photo page” 104 was provide once (i.e., 9.09%); “photo 1” 106 was provide once (i.e., 9.09%); “photo 2” 108 was provide once (i.e., 9.09%); “news page” 110 was provide twice (i.e., 18.18%); “blog page” 112 was provide once (i.e., 9.09%); “search page” 114 was provide once (i.e., 9.09%); and “news 2” 116 was provide once (i.e., 9.09%). Accordingly, if e.g., the maintainer of website 100 has a finite amount of resources to spend on maintaining website 100, the maintainer of website 100 may focus on maintaining “homepage” 102 and “news page” 110 due to their comparatively high levels of usage.

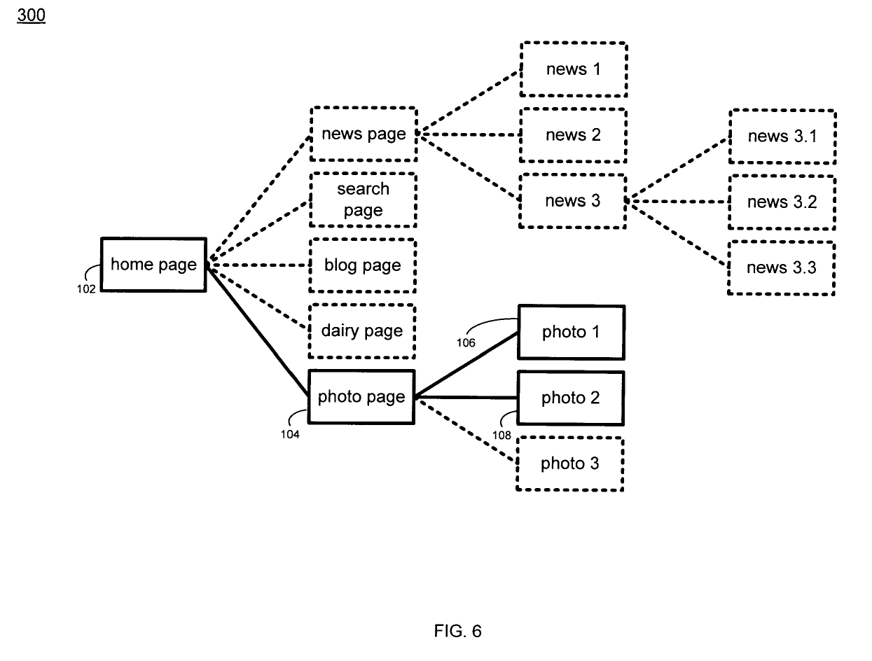

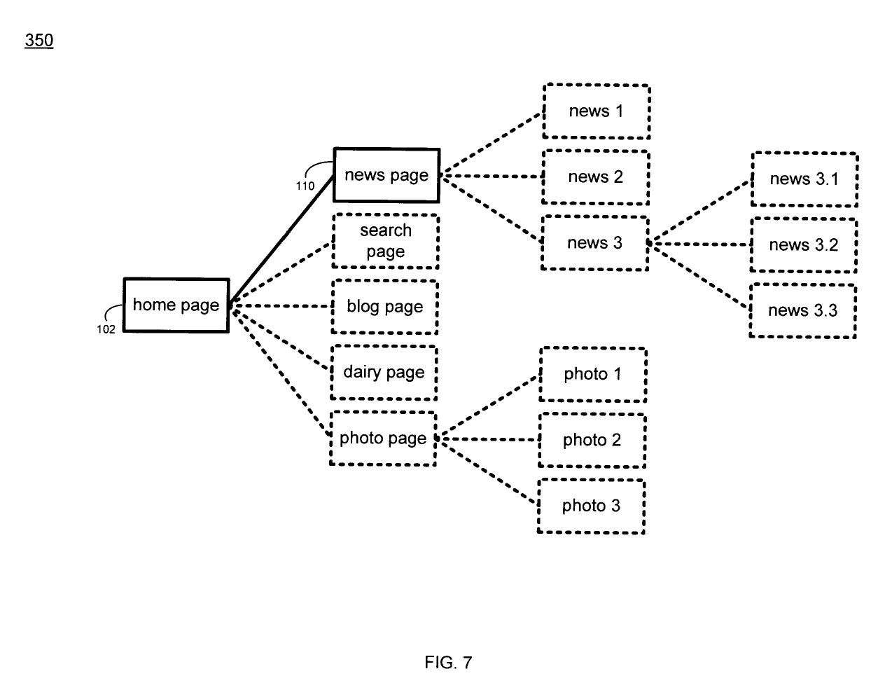

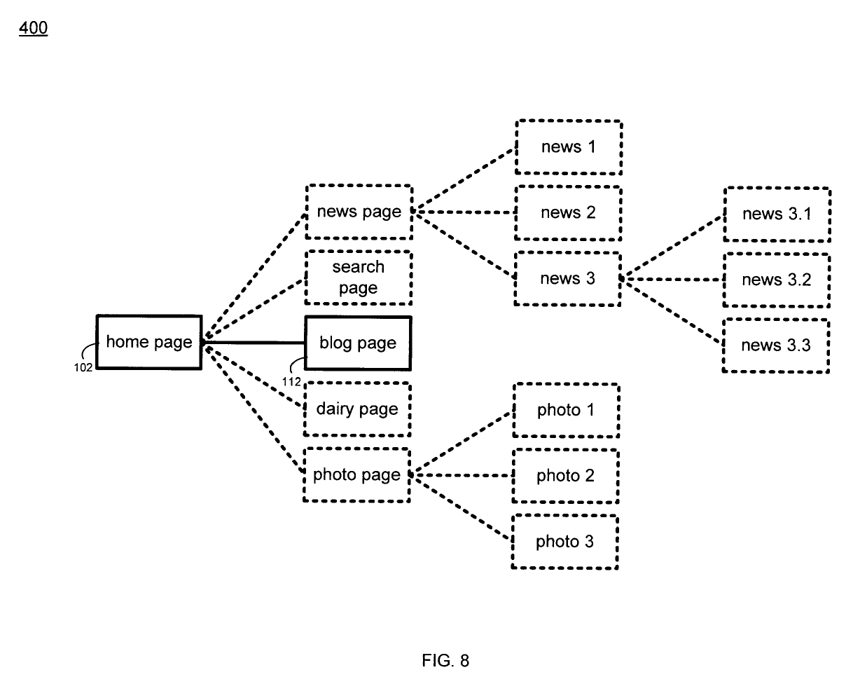

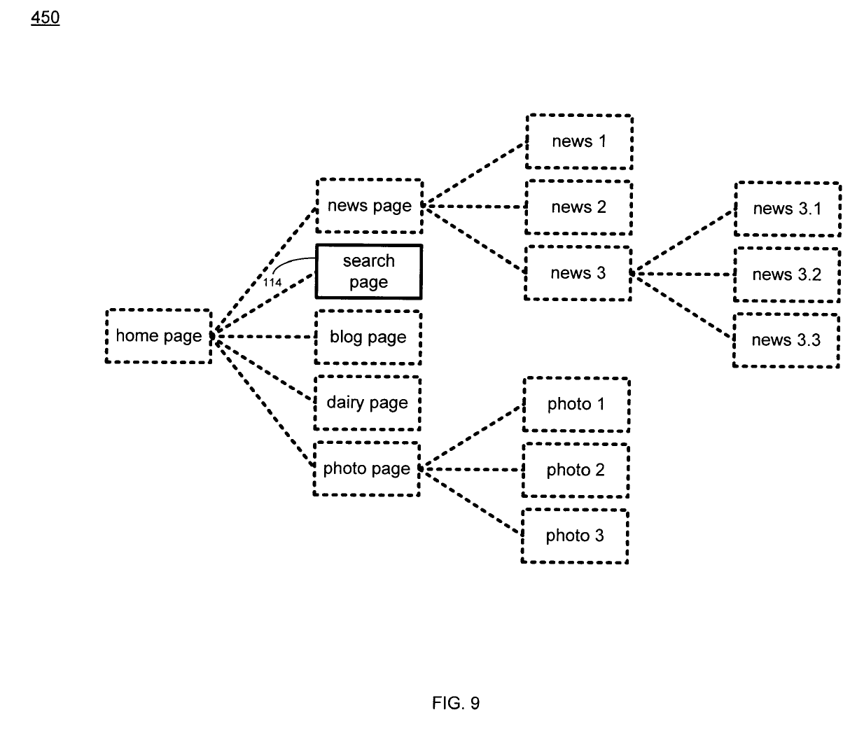

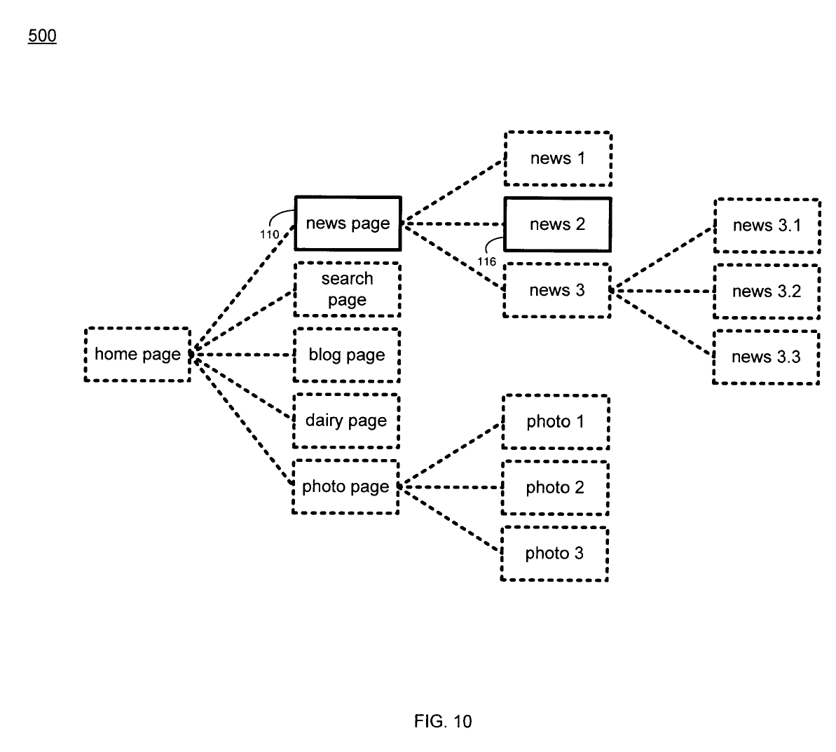

Additionally, by analyzing log file 68 and/or modified log file 68′, data acquisition process 10 may determine which portions of website 100 were used during each communication session. For example and referring also to session “01” flow diagram 300 of FIG. 6, for communication session “01” established between user computer 30 and server computer 12, data elements associated with “homepage” 102, “photo page” 104, “photo 1” 106, and “photo 2” 108 were provided by server computer 12. For example and referring also to session “02” flow diagram 350 of FIG. 7, for communication session “02” established between user computer 32 and server computer 12, data elements associated with “homepage” 102, and “news page” 110 were provided by server computer 12. For example and referring also to session “03” flow diagram 400 of FIG. 8, for communication session “03” established between personal digital assistant 34 and server computer 12, data elements associated with “homepage” 102, and “blog page” 112 were provided by server computer 12. For example and referring also to session “04” flow diagram 450 of FIG. 9, for communication session “04” established between data-enabled cellular telephone 36 and server computer 12, data elements associated with “search page” 114 were provided by server computer 12. For example and referring also to session “05” flow diagram 500 of FIG. 10, for communication session “05” (the second communication session established between personal digital assistant 34 and server computer 12), data elements associated with “news page” 110, and “news 2” 116 were provided by server computer 12.

By processing the data included within log file 68 and/or modified log file 68′, data acquisition process 10 may determine 170 one or more security vulnerabilities for e.g., website 100.

Application security testing evaluates the security of e.g., a website by simulating the attack of a hacker. By evaluating e.g., log file 68 and/or modified log file 68′, the probable traffic patterns within e.g., website 100 may be evaluated and prioritized. For example, for larger sites that include many thousands of pages of data, it may not be an efficient use of resources to evaluate each page for securities vulnerabilities. For example, assume that website 100 had 100,000 pages (instead of the fifteen pages shown in FIG. 2). Further, assume that for all the pages served by server computer 12 for website 100, 65.00% of them concerned “homepage” 102. Further, assume that 30.00% of the pages served by server computer 12 concerned “news page 110 and the remaining 5.00% were distributed amongst all of the remaining 999,998 webpages. When performing an application security test for website 100, due to their high levels of usage, it may be desirable to test the security of “homepage” 102 and “news page” 110 more thoroughly than the other pages includes within website 100. Accordingly, by analyzing log file 68 and/or modified log file 68′, the inbound data elements (e.g., data elements 60, 62, 64, 66) received by server computer 12 and the outbound data elements (e.g., data elements 70, 72, 74, 76) provided by server computer 12 may be determined. This, in turn, allows for the generation of “real world” flows through web site 100, as illustrated by: log file 68 (FIG. 4); modified log file 68′ (FIG. 5); session “01” flow diagram 300 (FIG. 6); session “02” flow diagram 350 (FIG. 7), session “03” flow diagram 400 (FIG. 8); session “04” flow diagram 450 (FIG. 9); and session “05” flow diagram 500 (FIG. 10). These “real world” flows may then be used to tailor application security testing flows/scripts that may be used during the automated and/or manual testing procedures (e.g., “spider” and “proxy server”) discussed above.

While data acquisition process 10 is described above as generating a log file 68 that may be used to e.g., determine 168 usage parameters for e.g., website 100 and determine 170 one or more security vulnerabilities for e.g., website 100, this is not intended to be a limitation of this disclosure and other uses of log file 68 are considered to be within the scope of this disclosure. For example, log file 68 may be used for performance testing (testing various workload scenarios), regression testing (testing whether a feature that used to work still works), and functional testing (testing application functionality).

A number of implementations have been described. Nevertheless, it will be understood that various modifications may be made. Accordingly, other implementations are within the scope of the following claims.

What is claimed is:

1. A method of capturing data comprising:
monitoring a plurality of inbound data elements that are received by a webserver that serves a website;
writing at least a portion of the plurality of inbound data elements to a log file for the website;
monitoring a plurality of outbound data elements that are to be transmitted by the webserver in response, at least in part, to the inbound data elements; and
writing at least a portion of the outbound data elements to the log file for the website.

2. The method of claim I further comprising:
assigning a session identifier to one or more of the inbound and outbound data elements; and
writing the session identifier to the log file for the website.

3. The method of claim 1 further comprising:
assigning a timestamp to one or more of the inbound and outbound data elements; and
writing the timestamp to the log file for the website.

4. The method of claim 1 wherein the outbound data elements include one or more of: JavaScript; cookies; POST data; HTML code; ASCII text; graphical elements; binary data, executable data, XML-formatted data, and formatted SOAP requests/responses.

5. The method of claim 1 wherein the outbound data elements define at least a portion of a webpage served by the webserver and included within the website.

6. A computer program product comprising a computer useable medium including a computer readable program, wherein the computer readable program when executed on a computer causes the computer to:
monitor a plurality of inbound data elements that are received by a webserver that serves a website;
write at least a portion of the plurality of inbound data elements to a log file for the website;
monitor a plurality of outbound data elements that are to be transmitted by the webserver in response, at least in part, to the inbound data elements; and
write at least a portion of the outbound data elements to the log file for the website.

7. The computer program product of claim 6 further comprising instructions for:
assigning a session identifier to one or more of the inbound and outbound data elements; and
writing the session identifier to the log file for the website.

8. The computer program product of claim 6 further comprising instructions for:
assigning a timestamp to one or more of the inbound and outbound data elements; and
writing the timestamp to the log file for the website.

9. The computer program product of claim 6 wherein the outbound data elements include one or more of: JavaScript; cookies; POST data; HTML code; ASCII text; graphical elements; binary data, executable data, XML-formatted data, and formatted SOAP requests/responses.

10. The computer program product of claim 6 wherein the outbound data elements define at least a portion of a webpage served by the webserver and included within the website.

11. A method of analyzing data comprising:
defining a log file that includes:
a plurality of inbound data elements that are received by a webserver; and
a plurality of outbound data elements that are to be transmitted by the webserver in response, at least in part, to the inbound data elements; and
parsing the log file into individual sessions.

12. The method of claim 11 wherein the outbound data elements include one or more of: JavaScript; cookies; POST data; HTML code; ASCII text; graphical elements; binary data, executable data, XML-formatted data, and formatted SOAP requests/responses.

13. The method of claim 11 wherein the outbound data elements define at least a portion of a webpage served by the webserver.

14. The method of claim 11 wherein the log file includes one or more session identifiers and one or more timestamps.

15. The method of claim 11 further comprising:
determining one or more usage parameters for one or more portions of the website.

16. The method of claim 11 further comprising:
determining one or more vulnerabilities for one or more portions of the website.

17. A computer program product comprising a computer useable medium including a computer readable program, wherein the computer readable program when executed on a computer causes the computer to:
define a log file that includes:
a plurality of inbound data elements that are received by a webserver; and
a plurality of outbound data elements that are to be transmitted by the webserver in response, at least in part, to the inbound data elements; and
parse the log file into individual sessions.

18. The computer program product of claim 17 wherein the outbound data elements include one or more of: JavaScript; cookies; POST data; HTML code; ASCII text; graphical elements; binary data, executable data, XML-formatted data, and formatted SOAP requests/responses.

19. The computer program product of claim 17 wherein the outbound data elements define at least a portion of a webpage served by the webserver.

20. The computer program product of claim 17 wherein the log file includes one or more session identifiers and one or more timestamps.

21. The computer program product of claim 17 further comprising instructions for:
determining one or more usage parameters for one or more portions of the website.

22. The computer program product of claim 17 further comprising instructions for: determining one or more vulnerabilities for one or more portions of the website.
